(19) United States
(12) Patent Application Publication
(10) Pub. No.: US 2024/0332222 A1
(43) Pub. Date: Oct. 3, 2024

(54) CONFIGURABLE SEMICONDUCTOR PACKAGE CAPACITORS AND METHOD

(71) Applicant: Intel Corporation, Santa Clara, CA (US)

(72) Inventors: Archanna Srinivasan, San Jose, CA (US); Guang Chen, Fremont, CA (US)

(73) Assignee: Intel Corporation, Santa Clara, CA (US)

(21) Appl. No.: 18/129,443

(22) Filed: Mar. 31, 2023

(51) Int. Cl. H01L 23/64; H01L 23/498; H01L 25/16

(52) U.S. Cl. CPC H01L 23/642; H01L 23/49816; H01L 25/16

(57) ABSTRACT

An electronic device and associated methods are disclosed. In one example, the electronic device includes plurality of metal-insulator-metal capacitor units and a control circuit to dynamically select different amounts of the plurality of metal-insulator-metal capacitor units in correlation to a type of operation in a semiconductor die.

### TECHNICAL FIELD

Embodiments described herein generally relate to electronic devices. Specific example devices include semiconductor devices utilizing capacitors to regulate power delivery to a semiconductor die.

### BACKGROUND

Capacitors are used in semiconductor devices as part of power regulation circuits. It is desired to more efficiently use capacitors to provide improved power regulation in electronic devices. Designs for current electronic devices include an amount of capacitance that is sufficient for a worst-case power delivery network load. This type of design can allocate more resources than needed for a given power delivery scenario. It is desired to provide electronic devices and power delivery networks that address these concerns, and other technical challenges.

### BRIEF DESCRIPTION OF THE DRAWINGS

FIG. 1 shows an electronic device in accordance with some example embodiments.

FIG. 2 shows a metal-insulator-metal capacitor in accordance with some example embodiments.

FIG. 3 shows a block diagram of an electronic device in accordance with some example embodiments.

FIG. 4 shows a portion of a a control circuit in accordance with some example embodiments.

FIG. 5 shows another electronic device in accordance with some example embodiments.

FIG. 6A shows a top view of another electronic device in accordance with some example embodiments.

FIG. 6B shows a side view of the electronic device from FIG. 6A, in accordance with some example embodiments.

FIG. 7 shows another electronic device in accordance with some example embodiments.

FIG. 8 shows a flow diagram of a method of operation of an electronic device in accordance with some example embodiments.

FIG. 9 shows a system that may incorporate metal-insulator-metal capacitor units and methods, in accordance with some example embodiments.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

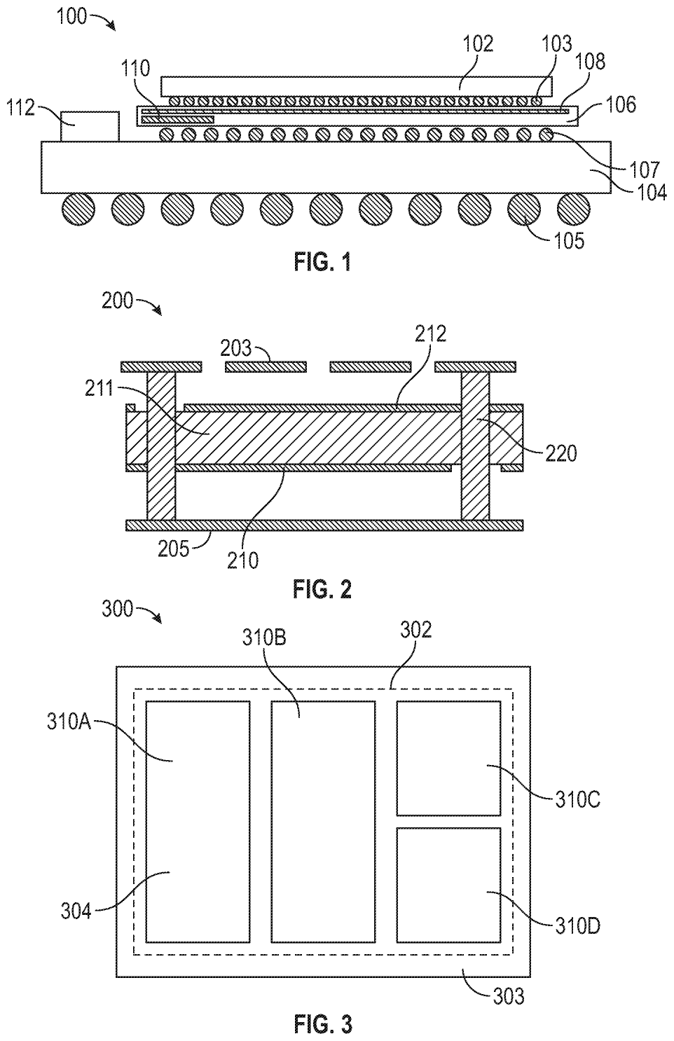

FIG. 1 shows an example of an electronic device 100. The device 100 includes a semiconductor die 102 coupled to a substrate 104. Although a single die 102 is shown in FIG. 1 for illustration, other electronic devices 100 may include multiple dies 102 on a single substrate 104, either stacked, or arranged side by side on the substrate 104.

An interposer 106 is shown coupled between the semiconductor die 102 and the substrate 104. Examples of interposers 106 may include organic based interposers, silicon interposers, glass interposers, etc. In the example of FIG. 1, the interposer 106 includes a plurality of metal-insulator-metal capacitor units 108. In one example, the metal-insulator-metal capacitor units 108 are located on a common layer within the interposer 106, although the invention is not so limited. In one example, the metal-insulator-metal capacitor units 108 are selectively coupled between a power connection on the substrate 104, and a power input on the semiconductor die 102.

Inclusion of an amount of capacitance, and an amount of inductance, is used to provide consistent power to the die 102. Different types of operations in the electronic device 100 and/or die 102 can require different power needs. In one example, a type of operation of the electronic device 100 is monitored, and an amount of metal-insulator-metal capacitor units 108 that are electrically coupled between a power connection on the substrate, and a power input on the semiconductor die is dynamically controlled as needed. Because metal-insulator-metal capacitor units 108 have low parasitic inductance, they are especially effective at power regulation, compared to other capacitors, such as package mounted capacitors.

The electronic device 100 of FIG. 1 further includes a control circuit 110. Although the control circuit 110 is shown located in the interposer 106, the invention is not so limited. Other locations, such as in the die 102, or in the package 104 are also possible. In one example, the control circuit 110 includes a field programmable gate array (FPGA) circuit. A location of the control circuit 110 in the interposer 106 provides an advantage in manufacturing. The electrical elements and arrangement of components such as switches and registers are more easily accommodated by fabricating in the interposer. Another location that is more easily accommodated is in a backside of a die, as discussed in more detail below. Including the control circuit 110 in an FPGA configuration is advantageous because programming the control circuit is more easily done, and is more configurable than other types of circuit.

A number of connections 105 such as solder ball connections, are shown at a bottom of the substrate. The connections 105 can be used to connect to other boards, such as a motherboard. A number of die connections 103 are shown for connection between the die 102 and the interposer 106. A number of interposer connections 107 are shown for connection between the interposer 106 and the substrate 104. Examples of connections 105, 103, 107 include power connection, data connections, etc. In one example, when in operation, the control circuit 110 is configured to dynamically control a selected amount of the metal-insulator-metal capacitor units 108 that are electrically coupled between a power connection on the substrate, and a power input on the semiconductor die.

The electronic device 100 of FIG. 1 further includes one or more package capacitors 112. The one or more package capacitors 112 may also be coupled between a power connection on the substrate, and a power input on the semiconductor die. In one example, the control circuit 110 is further configured to dynamically control a selected amount of the one or more package capacitors 112 that are electrically coupled between a power connection on the substrate, and a power input on the semiconductor die.

FIG. 2 shows a close up view of one example of metal-insulator-metal capacitor units 200 similar to metal-insulator-metal capacitor units 108. A first plate 210 and a second plate 212 are separated by a dielectric layer 211, for example, a layer within the interposer 106, a layer in a backside of the die 102, or a layer within the substrate 104. One or more power rails or ground is selectively coupled to plates 210, 212 by vias 220. A package side conductor layer 205 and a die side conductor layer 203 are patterned to provide connections to other pathway elements, such as connections 105, 103, 107 shown in FIG. 1.

FIG. 3 shows a block diagram of a layer 300 of metal-insulator-metal capacitor units 304. The layer 300 may be incorporated within an interposer, a die backside, a substrate, etc. In FIG. 3, a first metal-insulator-metal capacitor unit 310A, a second metal-insulator-metal capacitor unit 310B, a third metal-insulator-metal capacitor unit 310C, a fourth metal-insulator-metal capacitor unit 310D and a fifth metal-insulator-metal capacitor unit 310E are shown. Other numbers and geometric arrangements of metal-insulator-metal capacitor units 304 are also within the scope of the invention. A die shadow 302 is shown to indicate lateral location of the metal-insulator-metal capacitor units between a die 302 and a substrate 303. In operation, a more demanding device operation may employ all or most of the metal-insulator-metal capacitor units 304. Less demanding device operations may employ fewer or only one of the metal-insulator-metal capacitor units 304. How many, and which of the metal-insulator-metal capacitor units 304 are employed for a given device operation is controlled by a control circuit, such as the control circuit 110 from FIG. 1.

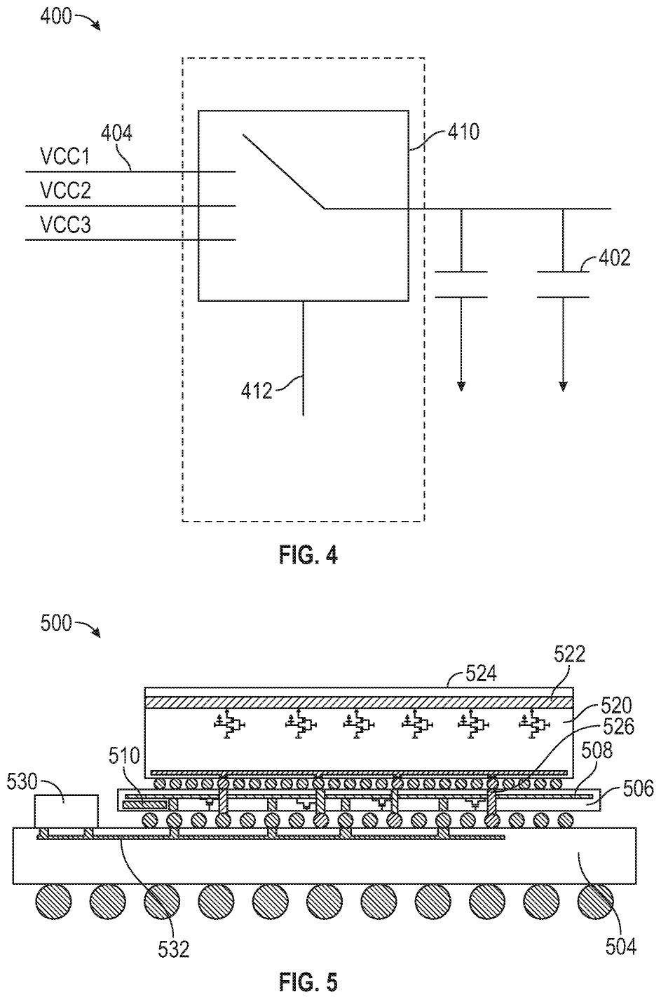

FIG. 4 shows an example diagram of a control circuit 400 similar to control circuit 110 from FIG. 1. The control circuit 400 shows a number of metal-insulator-metal capacitor units 402, and a number of power rails 404. A control signal is delivered on signal line 412 to a switch circuit 410 that in turn selectively employs the metal-insulator-metal capacitor units 402 to a selected power rail 404. The power rails 404 are in turn coupled to a die as described in examples above.

FIG. 5 shows another example electronic device 500. The device 500 includes a semiconductor die 520 coupled to a substrate 504. The die 520 in FIG. 5 is configured with an active device region 522 facing toward a top 524 of the electronic device 500. An interposer 506 is shown coupled between the semiconductor die 520 and the substrate 504. Examples of interposers 506 may include organic based interposers, silicon interposers, glass interposers, etc. In the example of FIG. 5, the interposer 506 includes a plurality of metal-insulator-metal capacitor units 508. In one example, the metal-insulator-metal capacitor units 508 are located on a common layer within the interposer 506, although the invention is not so limited. In one example, the metal-insulator-metal capacitor units 508 are selectively coupled between a power connection on the substrate 504, and a power input on the semiconductor die 520.

The electronic device 500 of FIG. 5 further includes a control circuit 510. Although the control circuit 510 is shown located in the interposer 506, the invention is not so limited. Other locations, such as in the die 520, or in the package 504 are also possible. In one example, the control circuit 510 includes a field programmable gate array (FPGA) circuit. A number of different power rails 526 are shown coupled between the substrate 504 and the die 520. In the example of FIG. 5, the power rails 526 pass through the interposer 506, where they are selectively coupled to a selected amount of metal-insulator-metal capacitor units 508 by the control circuit 510.

One or more package capacitors 530 are also shown. The one or more package capacitors 530 are also coupled between a power connection on the substrate, and a power input on the semiconductor die, using circuitry 532. This configuration provides additional capacitance options over the already configurable metal-insulator-metal capacitor units 508 in the interposer 506.

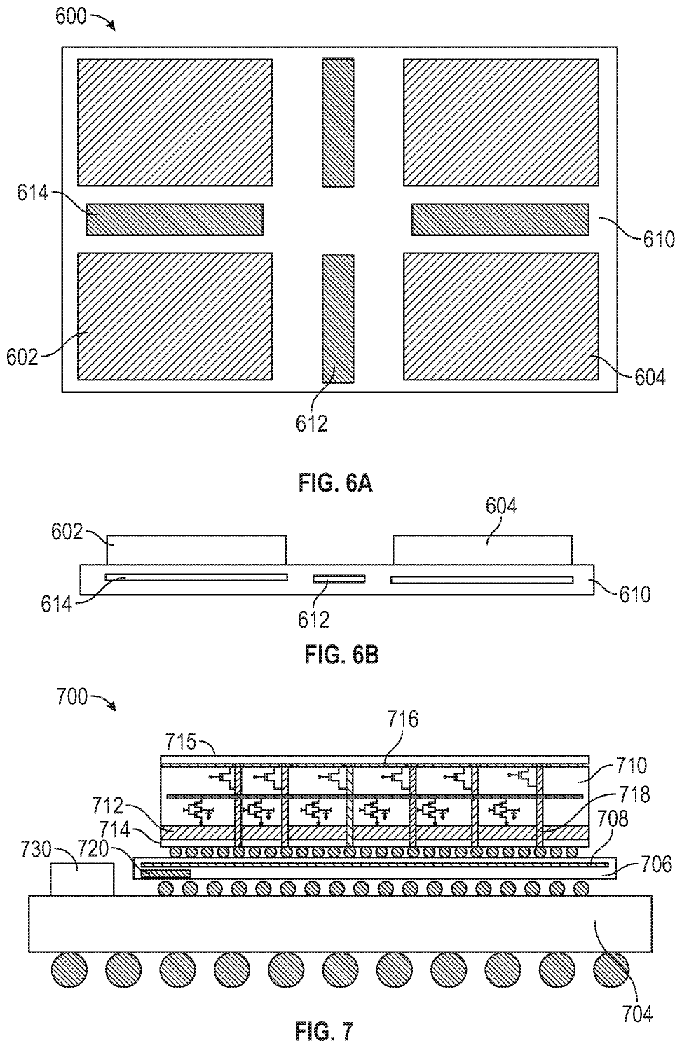

FIGS. 6A and 6B show different views of another example electronic device 600. The top view of the electronic device 600 shown in FIG. 6A includes a plurality of dies, including a first die 602 and a second die 604. An interposer 610 is shown coupled to the dies. A subsequent substrate (not shown) may also be included as a component in the electronic device 600. A number of individual metal-insulator-metal capacitor units are also shown, including a first metal-insulator-metal capacitor unit 612 and a second metal-insulator-metal capacitor unit 614. As shown in FIG. 6A, the number of individual metal-insulator-metal capacitor units are located laterally between dies.

FIG. 6B further illustrates the example locations of the metal-insulator-metal capacitor units. As seen in FIG. 6B, the interposer 610 is located below the dies 620, 604, however the first metal-insulator-metal capacitor unit 612 is located laterally between the dies 602 and 604.

FIG. 7 shows another example electronic device 700. The device 700 includes a semiconductor die 710 coupled to a substrate 704. The die 710 in FIG. 7 is configured with an active device region 712 facing toward a bottom 714 of the die 710. An interposer 706 is shown coupled between the semiconductor die 710 and the substrate 704. Examples of interposers 706 may include organic based interposers, silicon interposers, glass interposers, etc. In the example of FIG. 7, the interposer 706 includes a plurality of metal-insulator-metal capacitor units 708. In one example, the metal-insulator-metal capacitor units 708 are located on a common layer within the interposer 706, although the invention is not so limited. In one example, the metal-insulator-metal capacitor units 708 are selectively coupled between a power connection on the substrate 704, and a power input on the semiconductor die 710.

The electronic device 700 of FIG. 5 further includes a control circuit 720. Although the control circuit 720 is shown located in the interposer 706, the invention is not so limited. Other locations, such as in the die 710, or in the package 704 are also possible. In one example, the control circuit 720 includes a field programmable gate array (FPGA) circuit.

One or more package capacitors 730 are also shown. The one or more package capacitors 730 are also coupled between a power connection on the substrate, and a power input on the semiconductor die. This configuration provides additional capacitance options over the already configurable metal-insulator-metal capacitor units 708 in the interposer 706.

In the example of FIG. 7, a further plurality of backside metal-insulator-metal capacitor units 716 are located in a backside 715 of the die 710. The plurality of backside metal-insulator-metal capacitor units 716 are also coupled between a power connection on the substrate, and a power input on the semiconductor die. This configuration provides additional capacitance options over the already configurable metal-insulator-metal capacitor units 708 in the interposer 706. Although metal-insulator-metal capacitor units are shown in both the interposer 706 and the backside 715 of the die 710, other examples are possible where the configurable metal-insulator-metal capacitor units are only in the backside 715 of the die 710.

A number of different power rails 718 are shown coupled between the backside metal-insulator-metal capacitor units 716 and the active device region 712 of the die 520. In the example of FIG. 7, the plurality of metal-insulator-metal capacitor units 708, the backside metal-insulator-metal capacitor units 716, and the package capacitors 730 are all selectively coupled between a power connection on the substrate 704, and a power input on the semiconductor die 710 by the control circuit 720.

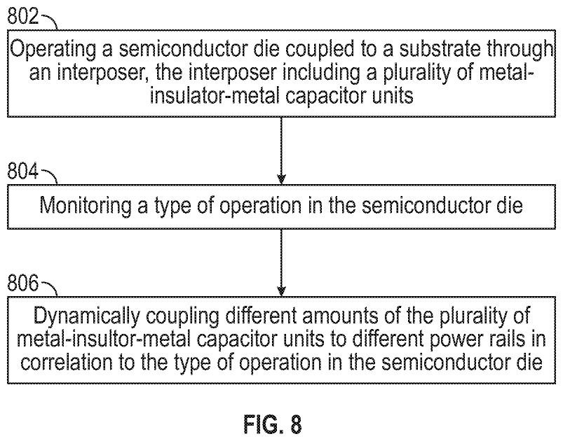

FIG. 8 shows an example flow diagram of a method of operating an electronic device as described in the present disclosure. In operation 802, a semiconductor die is operated to perform type of operation. The semiconductor die is coupled to a substrate through an interposer, and the interposer includes a plurality of metal-insulator-metal capacitor units. In operation 804, the type of operation in the semiconductor die is monitored, and in operation 806, different amounts of the plurality of metal-insulator-metal capacitor units are dynamically coupled to different power rails in correlation to the type of operation in the semiconductor die.

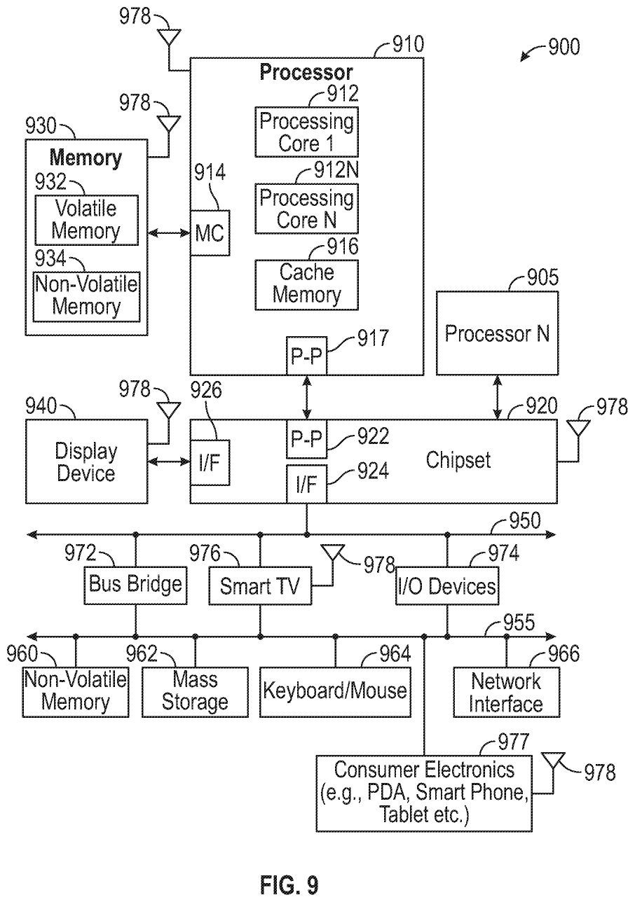

FIG. 9 illustrates a system level diagram, depicting an example of an electronic device (e.g., system) that may include dynamically selected amounts of metal-insulator-metal capacitor units and/or methods described above. In one embodiment, system 900 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance or any other type of computing device. In some embodiments, system 900 includes a system on a chip (SOC) system.

In one embodiment, processor 910 has one or more processor cores 912 and 912N, where 912N represents the Nth processor core inside processor 910 where N is a positive integer. In one embodiment, system 900 includes multiple processors including 910 and 905, where processor 905 has logic similar or identical to the logic of processor 910. In some embodiments, processing core 912 includes, but is not limited to, pre-fetch logic to fetch instructions, decode logic to decode the instructions, execution logic to execute instructions and the like. In some embodiments, processor 910 has a cache memory 916 to cache instructions and/or data for system 900. Cache memory 916 may be organized into a hierarchal structure including one or more levels of cache memory.

In some embodiments, processor 910 includes a memory controller 914, which is operable to perform functions that enable the processor 910 to access and communicate with memory 930 that includes a volatile memory 932 and/or a non-volatile memory 934. In some embodiments, processor 910 is coupled with memory 930 and chipset 920. Processor 910 may also be coupled to a wireless antenna 978 to communicate with any device configured to transmit and/or receive wireless signals. In one embodiment, an interface for wireless antenna 978 operates in accordance with, but is not limited to, the IEEE 802.11 standard and its related family, Home Plug AV (HPAV), Ultra Wide Band (UWB), Bluetooth, WiMax, or any form of wireless communication protocol.

In some embodiments, volatile memory 932 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. Non-volatile memory 934 includes, but is not limited to, flash memory, phase change memory (PCM), read-only memory (ROM), electrically erasable programmable read-only memory (EEPROM), or any other type of non-volatile memory device.

Memory 930 stores information and instructions to be executed by processor 910. In one embodiment, memory 930 may also store temporary variables or other intermediate information while processor 910 is executing instructions. In the illustrated embodiment, chipset 920 connects with processor 910 via Point-to-Point (PtP or P-P) interfaces 917 and 922. Chipset 920 enables processor 910 to connect to other elements in system 900. In some embodiments of the example system, interfaces 917 and 922 operate in accordance with a PtP communication protocol such as the Intel® QuickPath Interconnect (QPI) or the like. In other embodiments, a different interconnect may be used.

In some embodiments, chipset 920 is operable to communicate with processor 910, 905N, display device 940, and other devices, including a bus bridge 972, a smart TV 976, I/O devices 974, nonvolatile memory 960, a storage medium (such as one or more mass storage devices) 962, a keyboard/mouse 964, a network interface 966, and various forms of consumer electronics 977 (such as a PDA, smart phone, tablet etc.), etc. In one embodiment, chipset 920 couples with these devices through an interface 924. Chipset 920 may also be coupled to a wireless antenna 978 to communicate with any device configured to transmit and/or receive wireless signals. In one example, any combination of components in a chipset may be separated by a continuous flexible shield as described in the present disclosure.

Chipset 920 connects to display device 940 via interface 926. Display 940 may be, for example, a liquid crystal display (LCD), a light emitting diode (LED) array, an organic light emitting diode (OLED) array, or any other form of visual display device. In some embodiments of the example system, processor 910 and chipset 920 are merged into a single SOC. In addition, chipset 920 connects to one or more buses 950 and 955 that interconnect various system elements, such as I/O devices 974, nonvolatile memory 960, storage medium 962, a keyboard/mouse 964, and network interface 966. Buses 950 and 955 may be interconnected together via a bus bridge 972.

In one embodiment, mass storage device 962 includes, but is not limited to, a solid state drive, a hard disk drive, a universal serial bus flash memory drive, or any other form of computer data storage medium. In one embodiment, network interface 966 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 9 are depicted as separate blocks within the system 900, the functions performed by some of these blocks may be integrated within a single semiconductor circuit or may be implemented using two or more separate integrated circuits. For example, although cache memory 916 is depicted as a separate block within processor 910, cache memory 916 (or selected aspects of 916) can be incorporated into processor core 912.

To better illustrate the method and apparatuses disclosed herein, a non-limiting list of embodiments is provided here:

Example 1 includes an electronic device. The electronic device includes a semiconductor die coupled to a substrate, a plurality of metal-insulator-metal capacitor units, and a control circuit. When in operation, the control circuit is configured to dynamically control a selected amount of the metal-insulator-metal capacitor units that are electrically coupled between a power connection on the substrate, and a power input on the semiconductor die.

Example 2 includes the electronic device of example 1, wherein the plurality of metal-insulator-metal capacitor units are located in an interposer between the semiconductor die and the substrate.

Example 3 includes the electronic device of any one of examples 1-2, wherein the plurality of metal-insulator-metal capacitor units are located in a backside of the semiconductor die.

Example 4 includes the electronic device of any one of examples 1-3, wherein the plurality of metal-insulator-metal capacitor units are located in both an interposer, and in a backside of the semiconductor die.

Example 5 includes the electronic device of any one of examples 1-4, further including a package capacitor coupled to the control circuit.

Example 6 includes the electronic device of any one of examples 1-3, wherein the control circuit is located in the interposer.

Example 7 includes the electronic device of any one of examples 1-6, wherein the plurality of metal-insulator-metal capacitor units are located in an interposer between the semiconductor die and the substrate, and wherein the metal-insulator-metal capacitor units are selectively coupled to multiple power rails that pass through the interposer.

Example 8 includes the electronic device of any one of examples 1-7, wherein the semiconductor die is coupled to the substrate with an active surface facing away from the substrate.

Example 9 includes the electronic device of any one of examples 1-8, wherein the semiconductor die is coupled to the substrate with an active surface facing towards the substrate.

Example 10 includes an electronic device. The electronic device includes multiple semiconductor dies coupled to a substrate. The electronic device also includes a silicon interposer located between the multiple semiconductor dies and the substrate, and a plurality of metal-insulator-metal capacitor units in the silicon interposer. The electronic device also includes a control circuit. When the control circuit is in operation, the control circuit is configured to dynamically control a selected amount of the metal-insulator-metal capacitor units that are electrically coupled between a power connection on the substrate, and power inputs on the multiple semiconductor dies.

Example 11 includes the electronic device of example 10, wherein the control circuit is located in the silicon interposer.

Example 12 includes the electronic device of any one of examples 10-11, wherein the control circuit is located in a backside of at least one of the multiple semiconductor dies.

Example 13 includes the electronic device of any one of examples 10-12, wherein the plurality of metal-insulator-metal capacitor units are located laterally between dies in the multiple semiconductor dies.

Example 14 includes the electronic device of any one of examples 10-13, further including a package capacitor coupled to the control circuit.

Example 15 includes the electronic device of any one of examples 10-14, further including a second plurality of metal-insulator-metal capacitor units located in a backside of at least one of the multiple semiconductor dies and coupled to the control circuit.

Example 16 includes a method of operating an electronic device. The method includes operating a semiconductor die coupled to a substrate through an interposer, the interposer including a plurality of metal-insulator-metal capacitor units. The method also includes monitoring a type of operation in the semiconductor die, and dynamically coupling different amounts of the plurality of metal-insulator-metal capacitor units to different power rails in correlation to the type of operation in the semiconductor die.

Example 17 includes the method of example 16, wherein dynamically coupling includes operating a circuit locally in the interposer.

Example 18 includes the method of any one of examples 16-17, wherein dynamically coupling includes operating a field programmable gate array (FPGA) circuit.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. An electronic device, comprising:
a semiconductor die coupled to a substrate;
a plurality of metal-insulator-metal capacitor units; and
a control circuit, when in operation, configured to dynamically control a selected amount of the metal-insulator-metal capacitor units that are electrically coupled between a power connection on the substrate, and a power input on the semiconductor die.

2. The electronic device of claim 1, wherein the plurality of metal-insulator-metal capacitor units are located in an interposer between the semiconductor die and the substrate.

3. The electronic device of claim 1, wherein the plurality of metal-insulator-metal capacitor units are located in a backside of the semiconductor die.

4. The electronic device of claim 1, wherein the plurality of metal-insulator-metal capacitor units are located in both an interposer, and in a backside of the semiconductor die.

5. The electronic device of claim 1, further including a package capacitor coupled to the control circuit.

6. The electronic device of claim 1, wherein the control circuit is located in the interposer.

7. The electronic device of claim 1, wherein the plurality of metal-insulator-metal capacitor units are located in an interposer between the semiconductor die and the substrate; and
wherein the metal-insulator-metal capacitor units are selectively coupled to multiple power rails that pass through the interposer.

8. The electronic device of claim 1, wherein the semiconductor die is coupled to the substrate with an active surface facing away from the substrate.

9. The electronic device of claim 1, wherein the semiconductor die is coupled to the substrate with an active surface facing towards the substrate.

10. An electronic device, comprising:
multiple semiconductor dies coupled to a substrate;
a silicon interposer located between the multiple semiconductor dies and the substrate;
a plurality of metal-insulator-metal capacitor units in the silicon interposer; and
a control circuit, when in operation, configured to dynamically control a selected amount of the metal-insulator-metal capacitor units that are electrically coupled between a power connection on the substrate, and power inputs on the multiple semiconductor dies.

11. The electronic device of claim 10, wherein the control circuit is located in the silicon interposer.

12. The electronic device of claim 10, wherein the control circuit is located in a backside of at least one of the multiple semiconductor dies.

13. The electronic device of claim 10, wherein the plurality of metal-insulator-metal capacitor units are located laterally between dies in the multiple semiconductor dies.

14. The electronic device of claim 10, further including a package capacitor coupled to the control circuit.

15. The electronic device of claim 10, further including a second plurality of metal-insulator-metal capacitor units located in a backside of at least one of the multiple semiconductor dies and coupled to the control circuit.

16. A method of operating an electronic device, comprising:
operating a semiconductor die coupled to a substrate through an interposer, the interposer including a plurality of metal-insulator-metal capacitor units;
monitoring a type of operation in the semiconductor die; and
dynamically coupling different amounts of the plurality of metal-insulator-metal capacitor units to different power rails in correlation to the type of operation in the semiconductor die.

17. The method of claim 16, wherein dynamically coupling includes operating a circuit locally in the interposer.

18. The method of claim 16, wherein dynamically coupling includes operating a field programmable gate array (FPGA) circuit.
